(19) United States
(12) Patent Application Publication
(10) Pub. No.: US 2010/0166127 A1
(43) Pub. Date: Jul. 1, 2010

(54) APPARATUSES FOR TRANSMITTING AND RECEIVING DATA

(76) Inventor: Byung-Tak Jang, Bundang-gu (KR)

Correspondence Address: SHERR & VAUGHN, PLLC, 620 HERNDON PARKWAY, SUITE 320, HERNDON, VA, 20170, US

(21) Appl. No.: 12/643,682

(22) Filed: Dec. 21, 2009

(30) Foreign Application Priority Data
Dec. 30, 2008 (KR) 10-2008-0136906

(51) Int. Cl. H04L 7/00

(52) U.S. Cl. 375/354

(57) ABSTRACT

An apparatus for transmitting data comprises a clock signal generator generating clock signals; and a transmitter generating transmitting signals having same sized and shaped differential signals, i.e., the clock signals and data signals, subsequent to a strobe signal having common components different from those of the data signals. Accordingly, even though the distortion occurs in the strobe signal during transmission, the clock signal and the data signal can easily be recovered within a give action margin, and timing skew error variation between the clock signal and the data signal can be minimized by noise occurring in the transmission path, whereby the data signal can be transmitted at a higher frequency. Since the clock signal is recovered using the strobe signal, an area occupied by a circuit built in the apparatus for receiving data and used for recovery of the clock signal can be reduced.

The present application claims priority under 35 U.S.C. 119 to Korean Patent Application No. 10-2008-0136906 (filed on Dec. 30, 2008), which is hereby incorporated by reference in its entirety.

### BACKGROUND

As resolution of a display system such as a TV or a monitor increases, larger amounts of data need to be transmitted. Therefore, to reduce emission of electromagnetic waves when data are transmitted at a high data rate, mini-signal differential signaling is widely used.

FIG. 1 is a diagram illustrating a connection structure between a timing controller (TCON) 14 of a general display and source drivers 24. In a display, where one timing controller 14 is connected with a plurality of source drivers 24 in parallel, a data signal and a clock signal are transmitted between the timing controller 14 and the source drivers 24. The transmission mode has limitation due to a high data rate. In this respect, an advanced intra panel interface (AiPi), as well as point-to-point differential signaling (PPDS), which connect a timing controller with a source driver at 1:1, has been recently suggested.

In the PPDS, although a data signal is connected between the timing controller and the source driver at 1:1, a clock signal is shared by several source drivers in the same manner as the related art. Accordingly, the PPDS still has limitations.

Meanwhile, in the AiPi, since a clock signal and data signals or a control signal are transmitted in series through a single transmission path, the clock signal and the data signals have the same delay time. Accordingly, it is advantageous in that a skew error occurring between the clock signal and data signals during transmission can be reduced remarkably.

FIG. 2 is a diagram illustrating an example of transmitting signals in accordance with an AiPi transmission mode. As shown in FIG. 2, in the AiPi mode, a clock signal and data signals (0, 1, . . . n-2 and n-1) are formed in different sizes (i.e., magnitudes) and transmitted through the same transmission path. However, the clock signal is embedded with a signal level (i.e., signal magnitude) different from that of the data signals. Although the clock signal is easily identified from the transmitting signals, a reference signal for distinguishing between the clock signal from the data signals is required. The reference signal may be transmitted from the timing controller or may be generated by the source driver. Generally, if the reference signal is supplied from the outside, since it is shared with other source drivers, a transmission path of the respective data signals which are connected with each other at 1:1 is different from that of the clock signal, whereby the data signals are affected by noise differently from the clock signal during transmission. For this reason, the reference signal is susceptible to external noise occurring during transmission. Even in the case that the reference signal is generated by the source driver, a problem occurs in that noise occurring in the data signals and the clock signal during transmission cannot be reduced effectively. This could lead to a clock skew error between the data signals and the clock signal when the clock signal, having a different size from that of the data signals, is recovered. In this case, the error includes variation of the clock skew between the clock signal and the data signal as well as the clock skew between the clock signals. These two types of errors don't allow the exact position of data to be identified, when the recovered clock signal is used, and may indicate another location equivalent to the error.

### SUMMARY

Embodiments relate to a data interface, and more particularly, to apparatuses for transmitting and receiving data. Embodiments relate to an apparatus for transmitting data, which can transmit data signals and clock signals at a high data rate, wherein the data signals and the clock signals are robust and resistant to noise occurring during transmission or in a transmission path. Embodiments relate to an apparatus for receiving data which can easily recover clock signals from transmitting signals at a small circuit area.

Embodiments relate to an apparatus for transmitting data according to embodiments which may include: a clock signal generator for generating clock signals having a magnitude and duration; and a transmitter for transmitting differential clock and data signals, the clock and data signals having similar magnitudes and durations, subsequent to a strobe signal having common components different from common components of the data signals.

Embodiments also relate to an apparatus for receiving data which may include: a strobe signal extractor receiving transmitted clock signals and data signals having similar magnitudes and durations, subsequent to a strobe signal having common components different from those of the data signals, and extracting the strobe signal from the received signals; a clock recovery unit recovering the clock signals from the received signals using the extracted strobe signal; and a sampler sampling the data signals included in the transmitted signals, in response to the recovered clock signals.

Embodiments relate to apparatuses for transmitting and receiving data which may include: a timing controller for transmitting differential clock signals and data signals having similar magnitudes and durations, subsequent to a strobe signal having common components different from common components of the data signals; and a source driver for receiving the clock, data, and strobe signals, extracting the strobe signals from the received signals, recovering the clock signals using the extracted strobe signal, and sampling the data signals included in the received signals, using the recovered clock signals.

### DRAWINGS

FIG. 1 is a diagram illustrating a connection structure between a timing controller of a related display and source drivers.

FIG. 2 is a diagram illustrating an example of transmitting signals transmitted in accordance with an AiPi transmission mode.

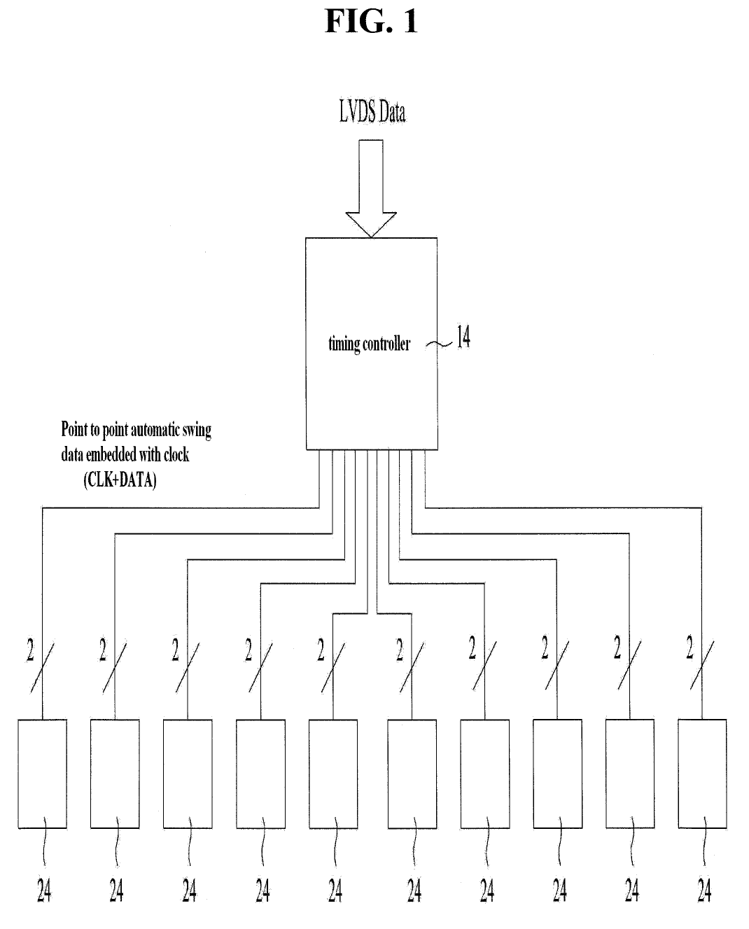

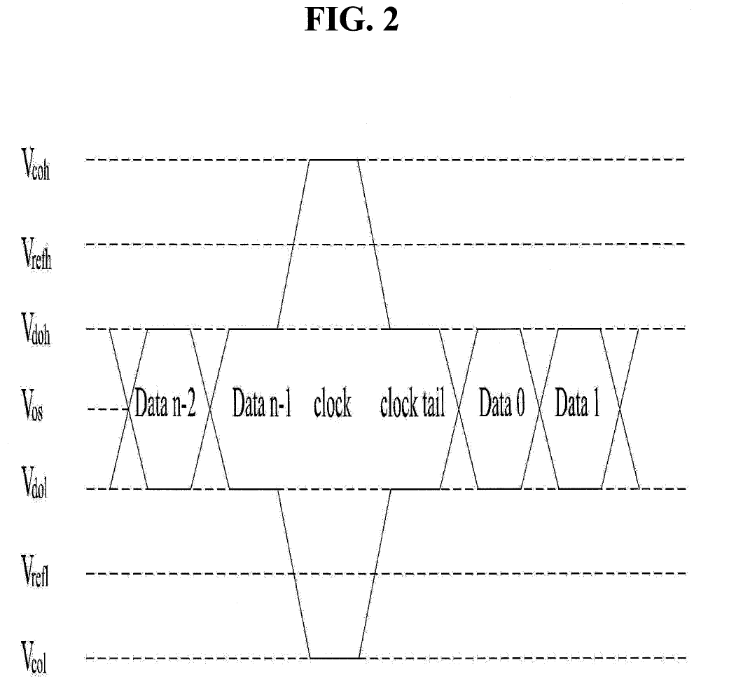

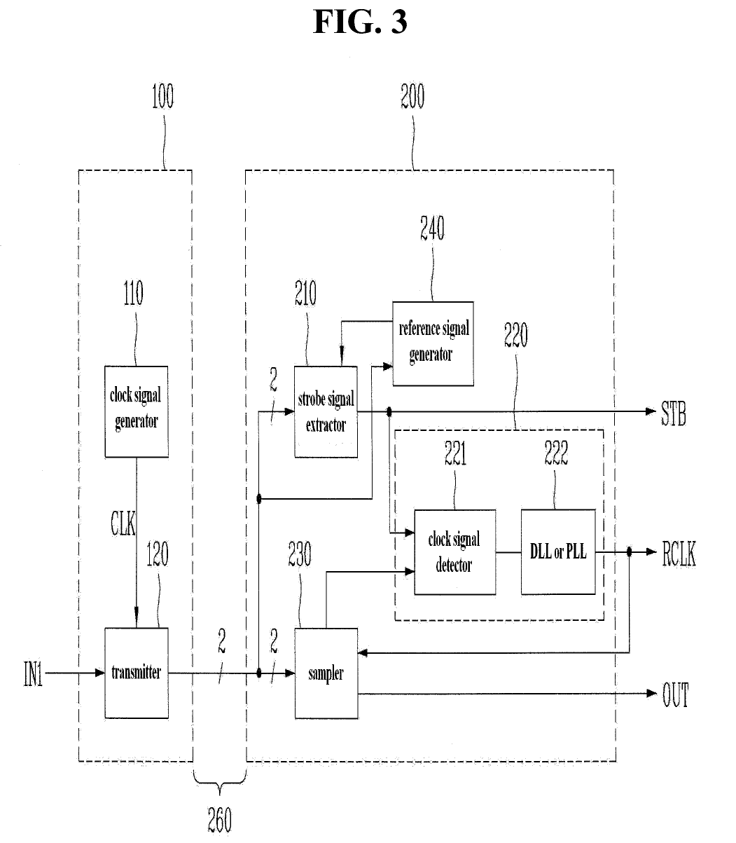

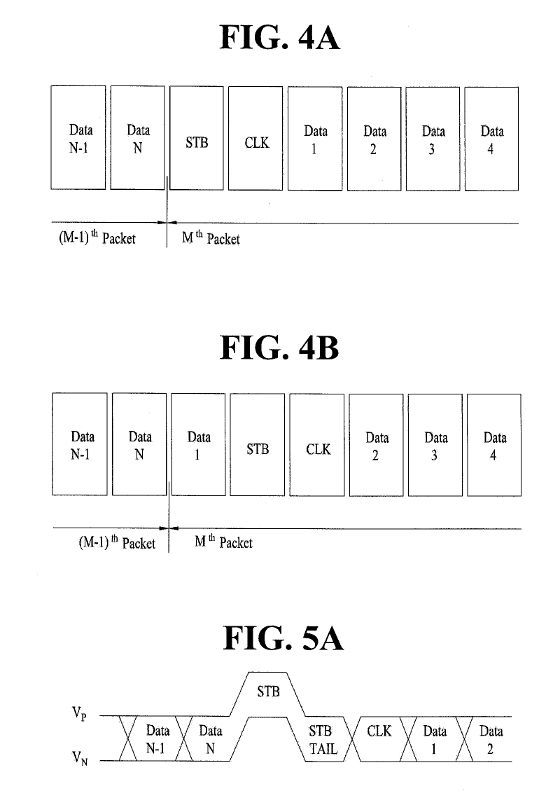

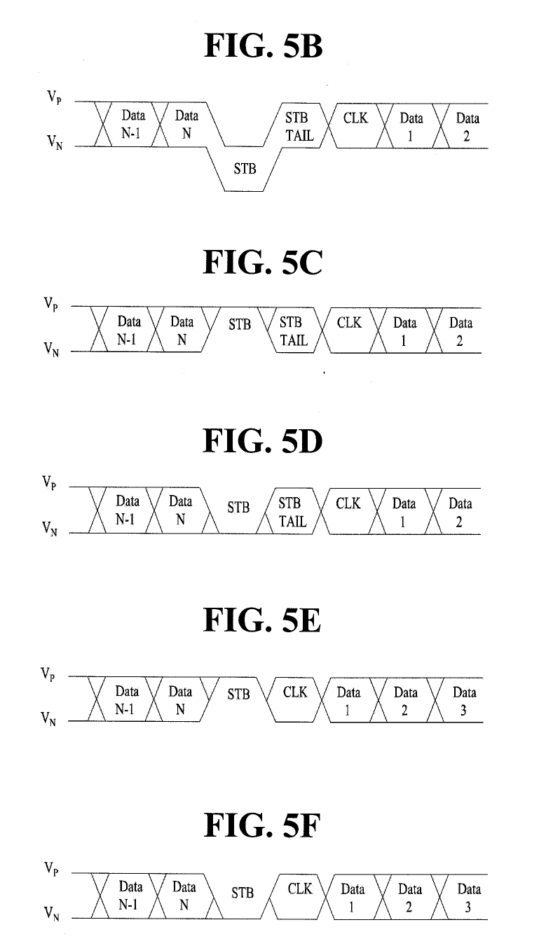

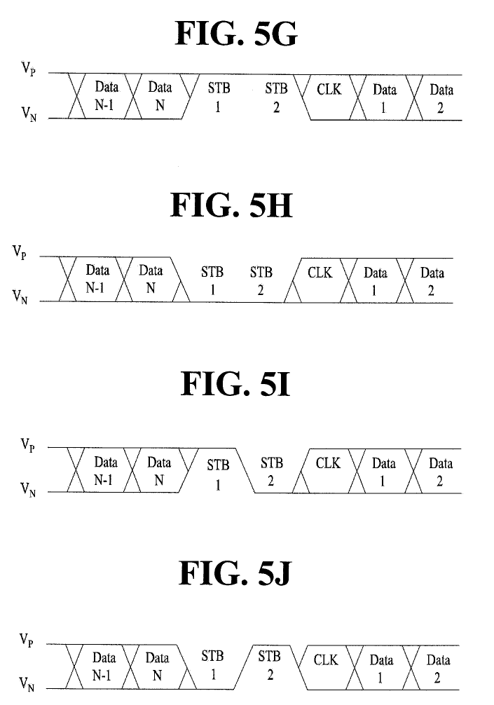

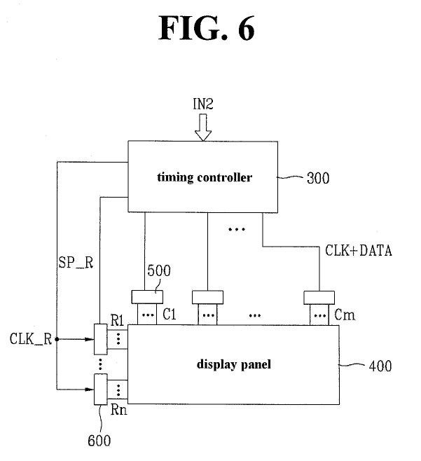

Example FIG. 3 is a block diagram illustrating an apparatus for transmitting data and an apparatus for receiving data in accordance with embodiments.

Example FIG. 4a and example FIG. 4b are diagrams illustrating a structure of a data packet according to embodiments.

Example FIG. 5A to example FIG. 5J are exemplary waveforms of transmitting signals generated by a transmitter according to embodiments.

Example FIG. 6 is a structural view of a display according to embodiments.

### DESCRIPTION

Example FIG. 3 is a block diagram illustrating an apparatus 100 for transmitting data and an apparatus 200 for receiving data in accordance with embodiments. The apparatus 100 for transmitting data as shown in example FIG. 3 may include a clock signal generator 110 and a transmitter 120. The clock signal generator 110 generates clock signals, and outputs the generated clock signals to the transmitter 120.

The transmitter 120 generates transmitting differential signals, i.e., clock signals and data signals, having substantially the same size and shape (i.e. magnitude and duration), subsequent to a strobe signal (STB:STroBe), and having common components different from those of data signals input through an input terminal IN1. The transmitter 120 transmits the generated signals to the apparatus 200 through a differential transmission path 260.

The strobe signal STB defined in embodiments is used to display the start and the end of sequentially input information. In other words, the strobe signal STB has information indicating to a receiver that one data packet (or set) ends and new data packet starts. Accordingly, the strobe signal STB does not include information to be transmitted. The strobe signal STB is different from the clock signals and the data signals in that it does not include timing information to read data. Generally, the strobe signal STB is included in a transmission protocol that operates a physical transmitting means in a data transmission system that include a transmitter, a receiver, and a channel.

Hereinafter, data packets of transmitting signals transmitted from an apparatus for transmitting data according to embodiments and their waveforms will be described with reference to the accompanying drawings. In this case, the data packets mean a series of data bits where clock signals and data signals are connected in series.

Example FIG. 4a and example FIG. 4b are diagrams illustrating a structure of a data packet according to embodiments. Referring to example FIG. 4a, each data packet includes a strobe signal STB, a clock signal CLK, and N number of data signals. According to embodiments, it is noted that a clock signal CLK and N number of data signals DATA 1, DATA 2, DATA 3, DATA 4, . . . , DATA N-1, and DATA N are arranged subsequent to a strobe signal STB, as shown in example FIG. 4A.

Alternatively, referring to example FIG. 4B, one data signal DATA 1 of a plurality of data signals may be arranged prior to the strobe signal STB. In this case, the data signal arranged prior to the strobe signal STB may be a random data signal including a number N of data signals. As shown in example FIG. 4B, the reason why a random data signal, for example, a first data signal DATA 1 is arranged prior to the strobe signal STB is as follows.

If the data signal DATA 1 is transmitted with given relationship with the strobe signal STB, i.e., if two signals DATA 1 and STB are transmitted with the same polarity, it is advantageous in that information of the data signal DATA 1 can be identified using polarity of the strobe signal STB even though an error occurs when the data signal DATA 1 is being transmitted. It is generally true that the strobe signal STB is transmitted with a lower error rate than the data signal. Accordingly, it is likely to recover the data signal DATA 1 as compared with other data signals even though an error occurs.

Meanwhile, the transmitter 120 transmits differential components of the strobe signal STB corresponding to the differential signal from the apparatus 100 for transmitting data to the apparatus 200 for receiving data through two lines of a channel 260. In transmitting signals, the differential components of the strobe signal STB can have different values, with different common components from those of the data signal DATA or the clock signal CLK. To assist understanding of embodiments, characteristics of the differential signal will be described in brief.

Generally, the differential signal has differential components. High components of the differential components will be defined as a ‘positive level’ and low components of them will be defined as a ‘negative level.’ Also, in differential signal transmission, the positive level is sent to one of two lines used as a channel while the negative level is sent to the other line. Generally, when data to be transmitted is high level, the line sending the positive level will be designated as a P-channel while the line sending the negative level will be designated as an N-channel.

However, when data to be transmitted is low level, the line sending the positive level will be designated as an N-channel while the line sending the negative level will be designated as a P-channel.

Example FIG. 5A to example FIG. 5J are exemplary waveforms of transmitted signals generated by a transmitter 120 according to embodiments. As shown in example FIG. 5A, the transmitter 120 can allow the common components of the strobe signal STB to be greater than those of the data signal DATA or the clock signal CLK. Alternatively, as shown in example FIG. 5B, the transmitter 120 can allow the common components of the strobe signal STB to be smaller than those of the data signal DATA or the clock signal CLK.

Also, the transmitter 120 can allow the size of the common components of the strobe signal STB to be different from that of the common components of the data signal DATA or the clock signal CLK. Generally, each of the differential components of the data signal and the clock signal has a size of a P-channel voltage Vp and a size of an N-channel voltage Vn. On the other hand, the strobe signal STB can have various sizes as follows.

For example, as shown in example FIG. 5C and example FIG. 5E, the size of the differential components of the strobe signal STB can have only the size of the P-channel voltage Vp. Alternatively, as shown in example FIG. 5D and example FIG. 5F, the size of the differential components of the strobe signal STB can have only the size of the N-channel voltage VN.

Also, as shown in example FIG. 5G and example FIG. 5J, the strobe signals STB may be arranged repeatedly in succession. If the strobe signals STB are sent repeatedly in succession, their reliability can be enhanced and the apparatus 200 for receiving data can easily detect the strobe signals STB.

According to embodiments, as shown in example FIG. 5G and example FIG. 5H, the differential components of the repeatedly arranged strobe signals STB can have the same size. In particular, the differential components of the repeatedly arranged strobe signals STB can have the size of the P-channel voltage Vp as shown in example FIG. 5G or the size of the N-channel voltage VN as shown in example FIG. 5H.

According to embodiments, as shown in example FIG. 5I and example FIG. 5J, the differential components of the repeatedly arranged strobe signals STB can have mixed sizes. In particular, as shown in example FIG. 5I, among the repeatedly arranged strobe signals STB, the differential components of the previously arranged strobe signals STB can have the size of the P-channel voltage Vp and the differential components of the subsequently arranged strobe signals STB can have the size of the N-channel voltage VN. Alternatively, as shown in example FIG. 5I, among the repeatedly arranged strobe signals STB, the differential components of the previously arranged strobe signals STB can have the size of the N-channel voltage VN and the differential components of the subsequently arranged strobe signals STB can have the size of the P-channel voltage VP.

According to embodiments, as shown in example FIG. 5A to example FIG. 5D, the transmitter 120 may generate the transmitting signals by inserting a strobe tail STB TAIL between the strobe signal STB and the clock signal CLK. The reason why the strobe tail is additionally transmitted is to attenuate signal distortion that may occur during transmission of an edge signal having great variation as the strobe signal STB may affect the subsequent clock signal CLK.

The strobe signal STB shown in example FIG. 5A and example FIG. 5B has amplitude greater than that of the data signal DATA or the clock signal CLK. However, the strobe signal STB shown in example FIG. 5C to example FIG. 5J has the same amplitude as that of the data signal DATA or the clock signal CLK. Since the strobe signal has variation within the same range as that of the data signal DATA or the clock signal CLK, the strobe tail STB TAIL may not be needed. For example, as shown in example FIG. 5E to example FIG. 5J, the transmitter 120 may generate the transmitting signals without inserting the strobe tail between the strobe signal STB and the clock signal CLK.

As described above, the apparatus 100 for transmitting data transmits the common components of the strobe signal by increasing or decreasing them as shown in example FIG. 5A and example FIG. 5B or varying the size of the strobe signal STB as shown in example FIG. 5C to example FIG. 5J. This is because the common components of the strobe signal STB are intended to be transmitted differently from those of the data signal DATA or the clock signal CLK. Since the strobe signal STB has common components different from those of the data signal DATA or the clock signal CLK, it can easily be detected from the apparatus 200 for receiving data. At this time, since the common components of the strobe signal STB are easily affected by external noise, the transmitter 120 should give variation to the common components of the strobe signal STB so that the common components have a size sufficient to disregard external noise.

According to embodiments, the transmitter 120 may stop transmission of the transmitting signals for a certain time period required to recover the clock signal CLK from the transmitting signals received by the apparatus for receiving the transmitting signals. The apparatus 100 for transmitting data does not transmit valid data to the apparatus for receiving data for the time period.

Hereinafter, the apparatus for receiving data according to embodiments will be described with reference to the accompanying drawings. The apparatus 200 for receiving data may include a strobe signal extractor 210, a clock recovery unit 220, and a sampler 230.

The strobe signal extractor 210 receives transmitting signals transmitted from the apparatus 100 for transmitting data through a channel 260, and extracts the strobe signal STB from the received transmitting signals. In this case, the transmitting signals are like those described in the apparatus 100 for transmitting data. Each element of the apparatus 200 for receiving data will be described in detail.

The strobe signal extractor 210 determines whether common components of the received transmitting signals have been varied, using a reference signal, and extracts the strobe signal from the transmitting signals using the determined result. Namely, the strobe signal extractor 210 determines whether there is valid change in the common components of the received transmitting signals, using the reference signal, and extracts the strobe signal STB through the determined result.

To this end, according to embodiments, the apparatus 200 for receiving data may further include a reference signal generator 240 as shown in example FIG. 3. The reference signal generator 240 accumulates the size of the differential components of the repeatedly received transmitting signals, calculates an average value of the accumulated values, and outputs the calculated average value to the strobe signal extractor 210 as the reference signal.

However, the reference signal may be generated by various methods as follows without being generated by the reference signal generator 240 shown in example FIG. 3. In this case, the apparatus 200 for receiving data shown in example FIG. 3 does not include the reference signal generator 240.

According to embodiments, the reference signal may previously be set as an optimized value. Namely, the apparatus 200 for receiving data may generate the reference signal by selecting a value of an optimized reference signal through an experiment such as varying the reference signal.

According to embodiments, the reference signal may be transmitted from the apparatus 100 for transmitting data to the apparatus 200 for receiving data together with the transmitting signals. In this case, if the size of the reference signal transmitted from the apparatus 100 for transmitting data is set to a too low value, less power consumption is required and transmission can easily be performed. However, the reference signal is more susceptible to external noise. Accordingly, the apparatus 100 for transmitting data needs to control the size of the reference signal by considering a level of noise occurring under the corresponding conditions. According to embodiments, the reference signal may be an average value of common components obtained by accumulating the common components of the transmitting signals and calculating the accumulated result.

Furthermore, the result obtained by increasing or decreasing the reference signal, which is obtained by various examples as described above, at a certain rate may be used as the reference signal. Namely, it may be determined whether common components of the received signals have been varied, using the resultant value obtained by increasing or decreasing the value of the reference signal obtained through the aforementioned examples. Finally, based on the reference signal as determined above, the strobe signal extractor 210 can recognize the strobe signal STB if there is variation in the common components of the received signals.

Meanwhile, the clock recovery unit 220 recovers the clock signal CLK from the received transmitting signals by using the strobe signal STB extracted from the strobe signal extractor 210. To this end, the clock recovery unit 220 may include a clock signal detector 221 and a delay-locked loop (DLL) 222 or a phase-locked loop (PLL) 222.

The clock signal detector 221 may detect one of a front edge and a rear edge of the clock signal input subsequent to the strobe signal STB received from the strobe signal extractor 210 in accordance with a signal CLK+DATA output from the sampler 230. Namely, the clock signal detector 221 may detect a clock edge from a crossing point of differential signals generated by the clock signal subsequent to the strobe signal STB. Afterwards, the clock signal detector 221 returns to the state where the clock edge is generated and prepares for a clock edge of next data packet. In this way, the clock signal detector 221 may detects one clock edge per data packet.

At this time, the DLL 222 may generate the received clock signal RCLK using the edge detected from the clock signal detector 221. Alternatively, the PLL 222 may generate the recovered clock signal RCLK using the edge detected from the clock signal detector 221. In this way, the clock RCLK, having an edge in the middle of data, can be recovered using the DLL or PLL 222.

The sampler 230 may sample the data signal included in the transmitted signals in response to the clock signal recovered by the clock recovery unit 220, and output the sampled result through an output terminal OUT. In addition, the process of recovering the data signal from the transmitting signals having a small size, received in the form of the differential signals, by using the recovered clock signal can be performed using a related method. Namely, as the received differential signals are compared with one another using a comparator, the signals are easily recovered to digital signals.

The aforementioned apparatus 100 for transmitting data and the aforementioned apparatus 200 for receiving data as shown in example FIG. 3 can be applied to various examples. Hereinafter, when the apparatuses 100 and 200 are applied to a display, the structure and operation of the apparatuses 100 and 200 will be described with reference to the accompanying drawing. However, embodiments are not limited to the following description.

Example FIG. 6 is a structural view of a display according to embodiments. Referring to example FIG. 6, the display may include a timing controller 300, a display panel 400, source drivers (or column drivers) 500, and gate drivers (or low drivers) 600. In this case, the source drivers 500 and the gate drivers 600 may be an integrated circuit (IC). The timing controller 300 controls the source drivers 500 and the gate drivers 600, and the source drivers 500 and the gate drivers 600 serve to drive the display panel 400. The display panel 400 may display images in accordance with scan signals R1 to Rn and data signals C1 to Cm. Examples of the display panel 400 include various display panels, such as a TFT liquid crystal displays (TFT-LCD), LCD panels, a plasma display panels (PDP), an organic luminescence electro display (OLED) panels and FEDs, which can be used between the timing controller 300 and a display driving integrated (DDI) circuit.

The gate drivers 600 may apply scan signals R1 to Rn to the display panel 400 while the source drivers 500 may apply data signals C1 to Cm to the display panel 400. The timing controller 300 receives picture data, i.e., low voltage differential signaling (LVDS) data and external clock signal LVDS CLK' through an input terminal IN2, shifts the received picture data to differential signals such as transistor-transistor logic (TTL) signals or transition minimized differential signals (TMDS), transfers signals of data signal DATA, strobe signal STB and clock signal CLK to the source drivers 500, and applies a clock signal CLK_R and a start pulse SP_R to the gate drivers 600. The data signal DATA transferred from the timing controller 300 to the source drivers 500 may include only picture (or image) data to be displayed in the display panel 400, or may further include a control signal.

The timing controller 300 corresponds to the apparatus 100 for transmitting data according to embodiments as shown in example FIG. 3. Namely, the timing controller 300 generates transmitting signals inserted with differential signals having the same size and the same shape, i.e., clock signal and data signal, subsequent to the strobe signal STB having common components different from those of the data signal generated from the data input through the input terminal IN2, and transmits the generated transmitting signals to the source drivers 500. As described above, the transmitting signals could be differential signals. In this case, only a pair of differential signals are used to transmit the strobe signal STB, the clock signal CLK and the data signal DATA from the timing controller 300 to one source driver 500.

At this time, although the timing controller 300 and the source driver 600 may transmit the data signal and the clock signal through a 1:1 (point to point) transmission path, embodiments are not limited to a 1:1 transmission path.

Meanwhile, the source drivers 500 correspond to the apparatus 200 for receiving data according to embodiments as shown in example FIG. 3. Namely, the source drivers 500 receive the transmitting signals transmitted from the timing controller 300, extract the strobe signal STB from the received transmitting signals, recovers the clock signal CLK from the extracted strobe signal STB, and samples the data signal DATA included in the transmitting signals using the recovered clock signal RCLK.

Finally, as described above, according to embodiments, since the data signal and the clock signal may be transmitted as the differential signals having the same size and the same shape through a single transmission process, timing skew error variation between the clock signal and the data signal can be minimized by noise occurring in the transmission path. Accordingly, less timing skew between the recovered clock signal and the data signal occurs. For this reason, the data signal can be transmitted at higher speed, i.e., a higher frequency. Also, since the strobe signal STB is transmitted prior to the clock signal CLK and the data signal DATA, the apparatus 200 for receiving data can easily detect the clock signal using the strobe signal STB. As a result, a structure of the clock signal detector built in the apparatus 200 for receiving data can be simplified.

Furthermore, since the strobe signal does not include timing information, even though distortion occurs in the strobe signal STB during transmission, the clock signal and the data signal are not affected within a given action margin. Also, even though the clock signal and the data signal have a delay time different from that of other clock signals and other data signals during recovery, the clock signal and the data signal can be recovered easily within a given range.

The aforementioned apparatuses for transmitting and receiving data according to embodiments may be applied to an interface for a next generation timing controller for television, a new data interface applicable to a source driver and a timing controller for chip on glass (COG), or a chip on film (COF) or tape carrier package (TCP) type timing controller and source driver.

In the apparatus for transmitting data according to embodiments, the strobe signal is transmitted prior to the clock signal and the data signal, which have the same size and the same shape. In the apparatus for receiving data according to embodiments, the strobe signal is recovered using the feature that the common components of the strobe signal are different from those of the clock signal or the data signal. Accordingly, even though distortion occurs in the strobe signal during transmission, the clock signal and the data signal can easily be recovered within a given action margin, and timing skew error variation between the clock signal and the data signal can be minimized by noise occurring in the transmission path, whereby the data signal can be transmitted at a higher frequency. Since the clock signal is recovered using the strobe signal, an area occupied by the circuit built in the apparatus for receiving data and used for recovery of the clock signal can be reduced.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a clock signal generator for generating clock signals having a magnitude and duration; and
a transmitter for transmitting differential clock and data signals, the clock and data signals having similar magnitudes and durations, subsequent to a strobe signal having common components different from common components of the data signals.

2. The apparatus of claim 1, wherein one of the data signals is arranged prior to the strobe signal.

3. The apparatus of claim 1, wherein the common components of the strobe signal are greater than the common components of the data signals.

4. The apparatus of claim 1, wherein the common components of the strobe signal are smaller than the common components of the data signals.

5. The apparatus of claim 1, wherein the strobe signal has differential components different from differential components of the clock signals and the data signals.

6. The apparatus of claim 1, wherein the strobe signal includes a strobe tail between the strobe signal and the clock signals.

7. The apparatus of claim 1, wherein the transmitter repeats the strobe signal in succession, without intervening clock and data signals.

8. The apparatus of claim 7, wherein the repeated strobe signals have differential components with the same magnitude.

9. The apparatus of claim 7, wherein the repeated strobe signals have differential components with different magnitudes.

10. The apparatus of claim 1, wherein the data signals include at least one of image data and a control signal.

11. The apparatus of claim 1, wherein the transmitter stops transmitting for a time period required for a receiver to recover the clock signals.

12. An apparatus, comprising:
a strobe signal extractor receiving transmitted clock signals and data signals having similar magnitudes and durations, subsequent to a strobe signal having common components different from those of the data signals, and extracting the strobe signal from the received signals;
a clock recovery unit recovering the clock signals from the received signals using the extracted strobe signal; and
a sampler sampling the data signals included in the transmitted signals, in response to the recovered clock signals.

13. The apparatus of claim 12, wherein the strobe signal extractor determines whether the common components of the received signals have been varied, using a reference signal, and extracts the strobe signal from the transmitted signals using the determined result.

14. The apparatus of claim 13, further comprising a reference signal generator accumulating a size of differential components of repeatedly received transmitting signals and outputting an average value of the accumulated values as the reference signal.

15. The apparatus of claim 13, wherein the reference signal is previously selected as an optimized value.

16. The apparatus of claim 13, wherein the reference signal is transmitted together with the transmitted signals.

17. The apparatus of claim 13, wherein the reference signal is an average value of common components of the transmitted signals.

18. The apparatus of claim 13, wherein it is determined whether the common components of the transmitted signals have been varied, using a resultant value obtained by one of increasing and decreasing a value of the reference signal at a given rate.

19. The apparatus of claim 12, wherein the clock recovery unit includes a clock signal detector for detecting at least one of a front edge and a rear edge of the clock signal input subsequent to the strobe signal.

20. The apparatus of claim 19, wherein the clock recovery unit further includes a delay-locked loop for generating the recovered clock signal using the detected edge.

21. The apparatus of claim 19, wherein the clock recovery unit further includes a phase-locked loop using the detected edge.

22. Apparatuses for transmitting and receiving data, comprising:
a timing controller for transmitting differential clock signals and data signals having similar magnitudes and durations, subsequent to a strobe signal having common components different from common components of the data signals; and
a source driver for receiving the clock, data, and strobe signals, extracting the strobe signals from the received signals, recovering the clock signals using the extracted strobe signal, and sampling the data signals included in the received signals, using the recovered clock signals.
